(19) United States
(12) Patent Application Publication
(10) Pub. No.: US 2024/0071682 A1
(43) Pub. Date: Feb. 29, 2024

(54) NEODYMIUM MAGNET AND METHOD FOR MANUFACTURING NEODYMIUM MAGNET BY THREE-DIMENSIONAL GRAIN BOUNDARY DIFFUSION

(71) Applicant: JL MAG RARE-EARTH (BAOTOU) CO., LTD., Baotou, Inner Mongolia (CN)

(72) Inventors: Minghuo LIAO, Ganzhou, Jiangxi (CN); Huayun MAO, Ganzhou, Jiangxi (CN); Yong LIU, Ganzhou, Jiangxi (CN); Congyao MAO, Ganzhou, Jiangxi (CN)

(73) Assignee: JL MAG RARE-EARTH (BAOTOU) CO., LTD., Baotou, Inner Mongolia (CN)

(21) Appl. No.: 18/261,086

(22) PCT Filed: Jun. 24, 2021
(86) PCT No.: PCT/CN2021/102058

§ 371 Date: Jul. 11, 2023

(30) Foreign Application Priority Data
Mar. 19, 2021 (CN) 202110296351.1

(51) Int. Cl. H01F 41/02; H01F 1/057

(52) U.S. Cl. CPC H01F 41/0293; H01F 1/0571

(57) ABSTRACT

A neodymium-iron-boron magnet is provided. The neodymium-iron-boron magnet is subject to diffusion and permeation of a heavy rare earth element, the neodymium-iron-boron magnet includes a heavy-rare-earth diffusion region at a surface layer and a core non-diffusion region, and the neodymium-iron-boron magnet has the heavy-rare-earth diffusion region at regions, which have normal directions consistent with three axes of a three-dimensional Cartesian coordinate system, of the surface layer. The present application extends the principle of diffusion from microscopic grains to macroscopic magnets. Diffusion layers of different depths may be obtained by adjusting temperature and time of heat treatment. Through the magnetic hardening of the surface layer of the magnet, the coercive force of the magnet is increased, and the magnet remanence (Br) and the maximum magnetic energy level (BHmax) are very slightly reduced. The producing process is simple, and highly controllable.

This application claims the priority of Chinese Patent Application No. 202110296351.1, filed with the China National Intellectual Property Administration on Mar. 19, 2021, and titled “NEODYMIUM-IRON-BORON MAGNET AND METHOD FOR PRODUCING THE SAME BY THREE-DIMENSIONAL GRAIN BOUNDARY DIFFUSION”, which is hereby incorporated by reference in entirety.

### FIELD

The present application belongs to the technical field of magnet production, which relates to a neodymium-iron-boron magnet and a method for producing the same, and in particular relates to a neodymium-iron-boron magnet and a method for producing the same by three-dimensional grain boundary diffusion.

### BACKGROUND

A neodymium-iron-boron magnet, also called neodymium magnet, with a chemical formula of Nd₂Fe₁₄B, is an artificial permanent magnet, which is a permanent magnet with the strongest magnetic force so far. The maximum magnetic energy product (BHmax) thereof is more than 10 times of that of ferrite, and the magnetic force can reach about 3500 Gauss in the state of bare magnet. At present, sintering is generally used to prepare a neodymium iron boron permanent magnet material in the industry. For example, as disclosed by Wei Wang et al. in “Effects of key process parameters and alloying on magnetic properties and mechanical properties of sintered NdFeB magnets”, the technological process for preparing the neodymium iron boron permanent magnet material by sintering generally includes the steps of batching, smelting, ingot crushing, powder making, hydrogen crushing to form ultrafine powder, orienting and pressing molding of the powder, vacuum sintering, inspection, electroplating, etc. The advantages of neodymium-iron-boron magnet include high cost performance, small size, light weight, good mechanical properties and strong magnetism. The advantages of such high energy density makes the neodymium iron boron permanent magnet materials widely used in modern industry and electronic technology, which are known as the king of magnetism in the field of magnetism. Therefore, the preparation and extension of neodymium-iron-boron magnet have always been a focus being continuously concerned in the industry.

Currently, the maximum magnetic energy product of sintered neodymium iron boron is close to the theoretical limit. However, the intrinsic coercivity is far below the theoretical limit. The traditional method for improving the intrinsic coercivity is to add heavy rare earth Dy/Tb in the smelting stage and to employ grain refinement process in the jet mill stage. The addition of a large amount of heavy rare earth in the smelting stage will cause significant increase of cost on one hand, and greatly reduce the remanence on the other hand. The reason is that the remanence is mainly determined by the volume fraction of matrix phase Nd₂Fe₁₄B, the higher the volume fraction of Nd₂Fe₁₄B, the higher the remanence. After being added, Dy and Tb replace part of Nd in the matrix phase Nd₂Fe₁₄B, to form (Nd, Dy)₂Fe₁₄B or (Nd, Tb)₂Fe₁₄B. The magnetic moments of Nd and Fe are arranged in parallel and point toward a same direction, and the magnetic moments are superimposed in the same direction. However, Dy/Tb and Fe are antiferromagnetic coupling, the magnetic moments of Dy/Tb and Fe are superimposed in opposite directions, resulting in significant reduction of remanence. The grain refinement process has high requirements on jet mill equipment. Besides, because the powder after grain refinement is easily oxidized, the requirements of anti-oxidation control during the production of the grain refinement process is high, which increases the process cost and results in a high defect rate.

In recent years, the grain boundary diffusion process has been used to increase the intrinsic coercivity of sintered neodymium iron boron, with very little reduction in the remanence and magnetic energy product of the magnet. The coercivity of sintered neodymium iron boron is determined by the anisotropy field of the matrix phase particles, while the magnetocrystalline anisotropy field of (Nd, Dy)₂Fe₁₄B or (Nd, Tb)₂Fe₁₄B generated by diffusion of high concentration of heavy rare earth is larger than that of Nd₂Fe₁₄B, therefore the coercivity can be significantly increased. In addition, the (Nd, Dy)₂Fe₁₄B or (Nd, Tb)₂Fe₁₄B strengthening phase is only deposited on the surface layer of the grains, and its volume fraction is very low compared to that of the grains of the Nd₂Fe₁₄B matrix phase. Therefore, the remanence (Br) and the maximum magnetic energy level (BHmax) of the magnet are very slightly reduced. The principle of grain boundary diffusion is to cover the outside of the magnet with powder or compound containing heavy rare earth element by coating, and then perform heat treatment to allow the heavy rare earth element to diffuse into the magnet along the Nd-rich liquid grain boundary phase. However, since the diffusion speed of Dy/Tb in the grain boundary is much higher than the diffusion speed inside the matrix phase grains, the diffused heavy rare earth is only deposited on the surface layer of the matrix phase grains, and rarely enters the inside of the grains.

Therefore, a technical problem to be solved by many front-line researchers and forward-looking manufacturers in the industry is to further improve the effect of grain boundary diffusion.

### SUMMARY

In view of this, the technical problem to be solved by the present application is to provide a neodymium-iron-boron magnet and a method for producing the same, particularly a method for producing a neodymium-iron-boron magnet by three-dimensional grain boundary diffusion. In the present application, the principle of diffusion is extended from microscopic grains to macroscopic magnets, that is, from the deposition of heavy rare earth on the surface layer of microscopic grains to the deposition of heavy rare earth on the surface of macroscopic magnets. Diffusion layers of different depths may be obtained by adjusting the temperature and time of heat treatment. Through the magnetic hardening of the surface layer of the magnet, the coercive force of the magnet is increased, and the magnet remanence (Br) and the maximum magnetic energy level (BHmax) are very slightly reduced. Moreover, the producing method has a simple process and is more suitable for industrialized popularization and application.

A neodymium-iron-boron magnet is provided according to the present application, wherein the neodymium-iron-boron magnet is subject to diffusion and permeation of a heavy rare earth element; the neodymium-iron-boron magnet includes a heavy-rare-earth diffusion region at a surface layer and a core non-diffusion region; and the neodymium-iron-boron magnet has the heavy-rare-earth diffusion region at the surface layer in each of the three-dimensional directions of the magnet.

Preferably, the heavy rare earth element includes Dy and/or Tb; and a volume fraction of the core non-diffusion region in the neodymium-iron-boron magnet is greater than or equal to 20%.

Preferably, the diffusion and permeation is three-dimensional grain boundary diffusion; the heavy-rare-earth diffusion region at the surface layer is provided on each of surfaces of the neodymium-iron-boron magnet; and an amount of the heavy rare earth element after the diffusion and permeation accounts for 0.1 wt % to 1.0 wt % of a mass of the neodymium-iron-boron magnet.

Preferably, a content of heavy rare earth in the core non-diffusion region does not increase before and after the diffusion and permeation; a center of the neodymium-iron-boron magnet is taken as a benchmark, a depth of the heavy-rare-earth diffusion region with respect to an outer surface of the corresponding surface layer of the neodymium-iron-boron magnet is within 80% of a distance from the outer surface to a center of the neodymium-iron-boron magnet; an Hcj of the neodymium-iron-boron magnet is increased by 2-15 kOe by the diffusion and permeation.

Preferably, in the heavy-rare-earth diffusion region and along an extending direction of the surface layer, a concentration of the heavy rare earth element at an edge is greater than a concentration of the heavy rare earth element in a central portion; in the heavy-rare-earth diffusion region and along an extending direction of the surface layer, the concentration of the heavy rare earth element first gradually decreases and then remains constant from the edge to the central portion; and in a depth direction of the heavy-rare-earth diffusion region toward a center of the neodymium-iron-boron magnet, the concentration of the heavy rare earth element gradually decreases.

A method for producing a neodymium-iron-boron magnet is further provided according to the present application, including the following steps:
A) mixing a heavy rare earth with an organic solvent to obtain a mixed solution;
B) coating the mixed solution obtained in the above step on each of surfaces of a raw neodymium iron boron to obtain a semi-finished product; and
C) performing grain boundary diffusion and aging treatment on the semi-finished product obtained in the above step to obtain the neodymium-iron-boron magnet.

Preferably, the organic solvent includes silicone oil; an average particle size of the heavy rare earth ranges from 1 μm to 100 μm; and a mass ratio of the heavy rare earth to the organic solvent is (90˜98):(2˜10).

Preferably, the raw neodymium iron boron includes a raw neodymium iron boron after surface polishing treatment; the grain boundary diffusion is specifically carried out under vacuum conditions; an absolute pressure of the vacuum is less than or equal to 10 Pa; and the grain boundary diffusion includes a step of low-temperature volatilization and a step of high-temperature diffusion.

Preferably, a temperature of the low-temperature volatilization is 300˜500° C.; a time of the low-temperature volatilization is 3˜5 h; a temperature of the high-temperature diffusion is 700˜1000° C.; and a time of the high-temperature diffusion is 1˜100 h.

Preferably, the aging treatment is specifically performed after cooling after the high-temperature diffusion; a temperature of the aging treatment is 400˜600° C.; and a time of the aging treatment is 1˜15 h.

A neodymium-iron-boron magnet is provided according to the present application. The neodymium-iron-boron magnet is subject to diffusion and permeation of a heavy rare earth element, the neodymium-iron-boron magnet includes a heavy-rare-earth diffusion region at a surface layer and a core non-diffusion region, and the neodymium-iron-boron magnet has the heavy-rare-earth diffusion region at the surface layer in each of the three-dimensional directions of the magnet. Compared with the prior art, the present application is based on the principle of grain boundary diffusion, the outside of the magnet is covered with powder or compound containing a heavy rare earth element by a coating method, and then the heavy rare earth element is allowed to diffuse into the inside of the magnet along the Nd-rich liquid grain-boundary phase. However, since the diffusion speed of Dy/Tb in the grain boundary is much greater than the diffusion speed inside the matrix phase grains, the diffused heavy rare earth is only deposited on the surface layer of the matrix phase grains, and rarely enters the inside of the grains.

The present application creatively extends the principle of diffusion from microscopic grains to macroscopic magnets, that is, from the deposition of heavy rare earth on the surface layer of microscopic grains to the deposition of heavy rare earth on the surface of macroscopic magnets, with more than 20% of the core volume not permeated. Diffusion layers of different depths can be obtained by adjusting the temperature and time of the heat treatment. Through the magnetic hardening of the surface layer of the magnet, the coercive force of the magnet is increased, and meantime the magnet remanence (Br) and the maximum magnetic energy level (BHmax) are very slightly reduced. In particular, when multiple magnets are used in combination, a single magnet may be regarded as a whole grain individual, which should have an excellent combination effect.

Compared with the existing grain boundary diffusion technology, in which diffusion is generally performed in only one direction (a magnetization direction or a non-magnetization direction) of the magnet, according to the three-dimensional grain boundary diffusion technology and the three-dimensional grain boundary diffused magnet provided by the present application, 0.10 wt %˜1.0 wt % of heavy rare earth may be added according to the characteristics of the product itself, and the heavy rare earth is deposited on the surface layer of the magnet through diffusion, with more than 20% of the core volume not permeated. In the three-dimensional directions, independent control can be realized according to different diffusion depths. Moreover, the producing process is simple, and highly controllable, which is more suitable for industrialized popularization and application.

The experimental results show that, compared with the traditional non-diffusion process, by using the three-dimensional grain boundary diffusion technology to add 0.1%˜0.5% Tb, an ultra-high performance magnet with Br>14.85 kGs and Hcj>21 kOe can be obtained, and such performance cannot be achieved by the non-diffusion process. In addition, to obtain the same performance, the addition amount of heavy rare earth in the three-dimensional grain boundary diffusion process is significantly reduced compared with that in the traditional non-diffusion process.

### BRIEF DESCRIPTION OF THE DRAWINGS

FIG. 1 is an EDS spectrogram of a cross section of a magnet sample 3 produced according to a first embodiment of the present application; and

FIG. 2 is a graph showing performance data of a comparative magnet sample 3 produced according to a second embodiment of the present application.

### DETAILED DESCRIPTION OF THE EMBODIMENTS

In order to further understand the present application, the preferred embodiments of the present application are described below in conjunction with embodiments. However, it should be understood that the description is only for further illustrating the features and advantages of the present application, rather than limiting the claims of the present application.

There are no special restrictions on sources of all raw materials in the present application. The raw materials may be purchased on the market or prepared according to conventional methods well known to those skilled in the art.

There are no special restrictions on purity of all the raw materials of the present application. In the present application, analytical purity or conventional purity used in the field of neodymium-iron-boron magnets may be preferably adopted.

A neodymium-iron-boron magnet is provided according to the present application, wherein the neodymium-iron-boron magnet is subject to diffusion and permeation of a heavy rare earth element; the neodymium-iron-boron magnet includes a heavy-rare-earth diffusion region at a surface layer and a core non-diffusion region; and the neodymium-iron-boron magnet has the heavy-rare-earth diffusion region at regions, which have normal directions consistent with three axes of a three-dimensional Cartesian coordinate system, of the surface layer.

In the present application, the heavy rare earth element preferably includes Dy and/or Tb, more preferably Tb or Dy, or a Dy—Tb alloy.

In the present application, a volume fraction of the core non-diffusion region in the neodymium-iron-boron magnet is greater than or equal to 20%, or greater than or equal to 30%, or greater than or equal to 50%.

In the present application, the neodymium-iron-boron magnet has the heavy-rare-earth diffusion region at the surface layer in each of the three-dimensional directions of the magnet, and the diffusion and permeation is preferably three-dimensional grain boundary diffusion. Specifically, the neodymium-iron-boron magnet of the present application has the heavy-rare-earth diffusion region at the surface layer on any one of surfaces of the neodymium-iron-boron magnet. That is, taking a cube as an example, in the six surfaces formed by length, width and height, each one of the surfaces has a heavy-rare-earth diffusion region at a surface layer.

In the present application, a diffusion and permeation amount of the heavy rare earth element preferably accounts for 0.1 wt %-1.0 wt % of a mass of the neodymium-iron-boron magnet, more preferably 0.3 wt %-0.8 wt %, and even more preferably 0.5 wt %-0.6 wt %.

In the present application, a content of the heavy rare earth in the core non-diffusion region does not increase before and after the diffusion and permeation. That is, the core is a non-diffusion region.

In the present application, a center of the neodymium-iron-boron magnet is taken as a benchmark, a depth of the heavy-rare-earth diffusion region with respect to an outer surface of the corresponding surface layer of the neodymium-iron-boron magnet is within 80% of a distance from the outer surface to a center of the neodymium-iron-boron magnet, more preferably within 60%, and even more preferably within 40%. Specifically, the depth may be 10%˜80%, or 20%˜70%, or 30%˜60%. In the present application, the distance from the surface to the center of the magnet is the height (length) from the surface to the center of the magnet. Regarding this distance, the same value may be selected for all the surfaces of the magnet, or different values may be selected for the surfaces of the magnet.

In the present application, compared with the neodymium-iron-boron magnet before diffusion and permeation, an Hcj of the neodymium-iron-boron magnet is preferably increased by 2˜15 kOe, more preferably by 5˜14 kOe, and even more preferably by 8˜13 kOe.

In the present application, in the heavy-rare-earth diffusion region and along an extending direction of the surface layer, a concentration of the heavy rare earth element at an edge is preferably greater than a concentration of the heavy rare earth element in a central portion. Specifically, in the heavy-rare-earth diffusion region and along an extending direction of the surface layer, the concentration of the heavy rare earth element preferably first gradually decreases and then remains constant. More specifically, in a depth direction of the heavy-rare-earth diffusion region toward a center of the neodymium-iron-boron magnet, the concentration of the heavy rare earth element preferably gradually decreases. This is the characteristics of the three-dimensional grain boundary diffusion of the present application. In the present application, taking any surface as a benchmark, the concentration of the heavy rare earth element gradually decreases from the view of the depth direction. Meanwhile, from a transverse view of the surface and the corresponding diffusion region, since there is diffusion in all the three-dimensional directions, the concentration of the heavy rare earth element at the edge is increased due to the diffusion of adjacent surfaces, that is, the concentration overlaps. However, in the central portion of the diffusion region, since the core of the magnet has a non-diffusion region, the central portion position in a transverse direction of each of the diffusion regions is not affected by the adjacent diffusion regions, and the concentration of the diffused element in the central portion is lower than that at the edge. Therefore, the overall trend of the concentration of the diffused element is first decreasing and then remaining constant from the edge to the central portion.

A method for producing a neodymium-iron-boron magnet is further provided, including the following steps:
A) mixing a heavy rare earth with an organic solvent to obtain a mixed solution;
B) coating the mixed solution obtained in the above step on each of surfaces of a raw neodymium iron boron to obtain a semi-finished product; and
C) performing grain boundary diffusion and aging treatment on the semi-finished product obtained in the above step to obtain the neodymium-iron-boron magnet.

In the present application, the heavy rare earth is mixed with the organic solvent, to obtain the mixed solution.

In the present application, the organic solvent preferably includes silicone oil.

In the present application, an average particle size of the heavy rare earth raw material is preferably 1˜100 μm, more preferably 5˜80 μm, more preferably 10˜60 μm, and even more preferably 20˜50 μm.

In the present application, a mass ratio of the heavy rare earth to the solvent is preferably (90˜98):(2˜10), more preferably (91˜97):(2˜10), more preferably (93˜95):(2˜10), or (90˜8):(3˜9), or (90˜98):(5˜7).

In the present application, the mixed solution obtained in the above step is subsequently coated on each of the surfaces of the raw neodymium iron boron, to obtain the semi-finished product.

In the present application, the raw neodymium iron boron may be in any shape, for example, a cube, a rectangular solid, a polygonal body, or a sphere, etc., and specifically may be a cube or a rectangular solid.

In the present application, the raw neodymium iron boron preferably includes a raw neodymium iron boron after surface polishing treatment.

In the present application, the grain boundary diffusion is specifically preferably performed under vacuum conditions. More specifically, an absolute pressure of a vacuum is preferably less than or equal to 10 Pa, more preferably less than or equal to 1 Pa, and even more preferably less than or equal to 0.1 Pa.

In the present application, the grain boundary diffusion preferably includes a step of low-temperature volatilization and a step of high-temperature diffusion.

A temperature of the low-temperature volatilization is preferably 300˜500° C., more preferably 325˜475° C., more preferably 350˜450° C., and even more preferably 375˜425° C. A time of the low-temperature volatilization is preferably 3˜5 h, more preferably 3.2˜4.8 h, more preferably 3.5˜4.5 h, and even more preferably 3.8˜4.3 h.

A temperature of the high-temperature diffusion of the present application is preferably 700˜1000° C., more preferably 750˜950° C., and even more preferably 800˜900° C. A time of the high-temperature diffusion is 1˜100 h, more preferably 5˜80 h, more preferably 10˜60 h, and even more preferably 20˜50 h.

In the present application, there are no special restrictions on the equipment for the grain boundary diffusion, the equipment for magnet grain boundary diffusion that is well known to those skilled in the art may be employed, which preferably may be a vacuum diffusion furnace, more preferably a sintering box with a flat bottom, and even more preferably a graphite box or a C/C composite board which is hardly deformable.

In the present application, in order to complete and refine the overall producing process, to better ensure the three-dimensional grain boundary diffusion effect of the neodymium-iron-boron magnet, and to better improve the magnetic properties of the neodymium-iron-boron magnet after diffusion, the method for producing the neodymium-iron-boron magnet, i.e., the diffusion and permeation process of the neodymium-iron-boron magnet, specifically includes the following steps:
Step 1. Preparing a magnet blank;
Step 2. Preparing a mixture of heavy rare earth and a solvent.
wherein silicone oil is selected to be the solvent, and an average particle size of the heavy rare earth is 1˜100 μm, so as to realize the dissolution of the heavy rare earth powder and also facilitate the volatilization of the solvent in the later diffusion process. More specifically, a mass ratio of the heavy rare earth powder to the solvent is (90˜98):(2˜10). In a specific embodiment, the mass ratio of the heavy rare earth powder to the solvent is 95:5;
Step 3: Coating the mixture containing the heavy rare earth powder and the solvent in the three-dimensional directions (on the six surfaces) of the neodymium-iron-boron magnet; performing grain boundary diffusion on the obtained neodymium-iron-boron magnet material, and then performing aging treatment after cooling, to obtain a three-dimensional grain boundary diffused neodymium-iron-boron magnet.

The process of the grain boundary diffusion specifically includes: the neodymium-iron-boron magnet material is kept at 300˜500° C. for 3˜5 h to volatilize the solvent in the mixture, and then the temperature is increased to 700˜1000° C. to perform diffusion for 1˜100 h. The temperature of the aging treatment is 400˜600° C., and the time is 1˜15 h.

In the present application, there are no special restrictions on the raw neodymium iron boron, the raw neodymium iron boron which is well known to those skilled in the art may be employed, that is, the raw neodymium iron boron prepared from the neodymium iron boron raw material being subject to steps of batching, smelting, crushing and powder making, orienting and pressing molding of the powder, and vacuum sintering, etc., after surface treatment and processing, may serve as the ordinary blank of a finished neodymium-iron-boron magnet. In the present application, in order to better improve the properties of the neodymium-iron-boron magnet, the raw neodymium iron boron is preferably processed to be a semi-finished product having a size close to that of the finished product, and a dimension of the semi-finished product along its orientation is close to that of the finished product. More preferably, on this basis, the raw neodymium iron boron is subject to pretreatments such as degreasing and cleaning to make the surfaces smooth and clean, so as to achieve a better diffusion effect.

In the present application, the neodymium-iron-boron magnet is obtained after the above steps. In the present application, there are no special restrictions on post-processing steps such as cleaning, slicing, etc., which may be included after the above steps, and those skilled in the art may make adjustments or selections according to actual production conditions, product requirements, and the like.

A neodymium-iron-boron magnet and a method for producing a neodymium-iron-boron magnet by three-dimensional grain boundary diffusion are provided according to the above steps of the present application. In the present application, the principle of diffusion is extended from microscopic grains to macroscopic magnets, that is, from the deposition of heavy rare earth on the surface layer of microscopic grains to the deposition of heavy rare earth on the surface of macroscopic magnets, with more than 20% of the core volume not permeated. Diffusion layers of different depths may be obtained by adjusting the temperature and time of the heat treatment. Through the magnetic hardening of the surface layer of the magnet, the coercive force of the magnet is increased, and meantime the magnet remanence (Br) and the maximum magnetic energy level (BHmax) are very slightly reduced. In particular, when multiple magnets are used in combination, a single magnet may be regarded as a whole grain individual, which should have an excellent combination effect.

Compared with the existing grain boundary diffusion technology, in which diffusion is generally performed in only one direction (a magnetization direction or a non-magnetization direction) of the magnet, according to the three-dimensional grain boundary diffusion technology and the three-dimensional grain boundary diffused magnet provided by the present application, the magnet is a neodymium-iron-boron magnet with magnetically hardened surface layer, including a heavy rare earth element diffusion region having a depth of 0˜10 mm from the surface of the magnet to the inside of the magnet, with a content of the heavy rare earth in the diffusion region higher than that of the base material. More than 20% of the core area is not subject to diffusion treatment at all, which still remains the composition and performance of the base material. In the present application, the heavy rare earth of 0.10 wt %˜1.0 wt % may be added according to the characteristics of the product itself, and the heavy rare earth is deposited on the surface layer of the magnet through diffusion, with more than 20% of the core volume not permeated. In the three-dimensional directions, by adjusting the temperature and holding time of the heat treatment, independent control can be realized according to different diffusion depths, thus obtaining neodymium-iron-boron magnets with different diffusion depths. Moreover, the producing process is simple, and highly controllable, which is more suitable for industrialized popularization and application.

The experimental results show that, compared with the traditional non-diffusion process, by using the three-dimensional grain boundary diffusion technology to add 0.1%˜0.5% Tb, an ultra-high performance magnet with Br>14.85 kGs and Hcj>21 kOe can be obtained, and such performance cannot be achieved by the non-diffusion process. In addition, to obtain the same performance, the addition amount of heavy rare earth in the three-dimensional grain boundary diffusion process is significantly reduced compared with that in the traditional non-diffusion process. Besides, the three-dimensional grain boundary diffusion process e can be independently controlled in the three-dimensional direction of the product according to different diffusion depths.

In order to further illustrate the present application, the neodymium-iron-boron magnet and the method for producing the same according to the present application will be described in detail below in conjunction with embodiments. However, it should be understood that these embodiments are implemented based on the technical solutions of the present application. The detailed embodiments and specific operation processes are provided only to further illustrate the features and advantages of the present application, rather than to limit the claims of the present application, and the protection scope of the present application is not limited to the following embodiments.

### First Embodiment

The terbium metal powder with an average particle size of 3-4 microns was provided. The terbium powder was put into the silicone oil in a glove box under protection of a nitrogen atmosphere, where a weight ratio of the terbium powder to the silicone oil is 95:5, and then was stirred well for use.

50 N56 blanks were provided, and the blanks were sampled for test performance, as shown in Table 1:

TABLE 1
Magnetic performance data table of N56 blanks

| | Br | HCb | HCJ | | |
|---|---|---|---|---|---|
| Sample type | (KGs) | (KOe) | (KOe) | Hk/HCj | BH(MAX)(MGsOe) |
| Performance | 14.99 | 12.95 | 13.07 | 0.98 | 54.21 |
| of the blank | | | | | |

Each of the blanks was cut into rectangle pieces of 40*20*6 (mm), and there are 240 sample pieces in total. The samples were equally divided into 4 groups with 60 pieces in each group.

The first group was the original sample of the base material with no coating or diffusion treatment, to serve as the comparative sample 1.

The remaining samples were coated with the prepared mixture of Tb metal powder and silicone oil evenly on six surfaces by specialized coating equipment, and the amount of Tb was 0.2% of the sample weight.

The second group: 60 coated sample pieces were placed in a vacuum diffusion furnace. First, the temperature was held at 400° C. for 4 hours to dry the silicone oil, and the silicone oil was discharged out of the diffusion furnace through the vacuum system of the vacuum furnace; then the temperature was raised to 7001000° C. for grain boundary diffusion treatment with a diffusion time of 5 hours; after the diffusion was completed, the temperature was rapidly lowered to below 80° C. and then raised to 500° C. for aging treatment with an aging time of 5 hours; and after the aging treatment was completed, the temperature was rapidly lowered to below 80° C. again for taking the sample pieces out of the furnace, and 60 treated sample pieces were obtained to serve as the comparative sample 2.

The third group: 60 coated sample pieces were placed in a vacuum diffusion furnace. First, the temperature was held at 400° C. for 4 hours to dry the silicone oil, and the silicone oil was discharged into the diffusion furnace through the vacuum system of the vacuum furnace; then the temperature was raised to 7001000° C. for grain boundary diffusion treatment with a diffusion time of 10 hours; after the diffusion was completed, the temperature was rapidly lowered to below 80° C. and then raised to 500° C. for aging treatment with an aging time of 5 hours; and after the aging treatment was completed, the temperature was rapidly lowered to below 80° C. again for taking the sample pieces out of the furnace, and 60 treated sample pieces were obtained to serve as the comparative sample 3.

The fourth group: 60 coated sample pieces were placed in a vacuum diffusion furnace. First, the temperature was held at 400° C. for 4 hours to dry the silicone oil, and the silicone oil was discharged into the diffusion furnace through the vacuum system of the vacuum furnace; then the temperature was raised to 7001000° C. for grain boundary diffusion treatment with a diffusion time of 25 hours; after the diffusion was completed, the temperature was rapidly lowered to below 80° C. and then raised to 500° C. for aging treatment with an aging time of 5 hours; and after the aging treatment was completed, the temperature was rapidly lowered to below 80° C. again for taking the sample pieces out of the furnace, and 60 treated sample pieces were obtained to serve as the comparative sample 4.

An energy dispersive spectrum (EDS) comparison test was performed on different areas of each of the four groups of samples, and the results are shown in Table 2.

TABLE 2
Tb content data of four groups of samples at different
depths from the surface of the magnet

| | | Tb mass fraction at different depths | | | | | | |
|---|---|---|---|---|---|---|---|---|
| | Diffu- | from the surface of the magnet (%) | | | | | | |
| Sample | sion | 0.5 | 0.8 | 1 | 1.5 | 2.0 | 2.5 | 3.0 |
| type | time | mm | mm | mm | mm | mm | mm | mm |
| Comparative | 0 h | 0.00 | 0.00 | 0.00 | 0.00 | 0.00 | 0.00 | 0.00 |
| sample 1 | | | | | | | | |
| Comparative | 5 h | 0.55 | 0.42 | 0.05 | 0.00 | 0.00 | 0.00 | 0.00 |
| sample 2 | | | | | | | | |
| Comparative | 10 h | 0.45 | 0.32 | 0.10 | 0.05 | 0.00 | 0.00 | 0.00 |
| sample 3 | | | | | | | | |
| Comparative | 25 h | 0.21 | 0.21 | 0.21 | 0.20 | 0.21 | 0.20 | 0.20 |
| sample 4 | | | | | | | | |

It can be seen from Table 2 that in the processes of 5 h and 10 h diffusion, diffusion strengthening only occurs in the surface layer of the magnet, and no Tb element was detected in the core. In the process of 25 h diffusion, the Tb content of the core of the magnet was equivalent to that of the surface, that is, under this process, completely diffusion occurred inside the magnet. It demonstrates that by controlling the diffusion time, it could realize the purpose that the heavy rare earth was only deposited on the surface layer of the magnet and not diffused in more than 20% of the core region.

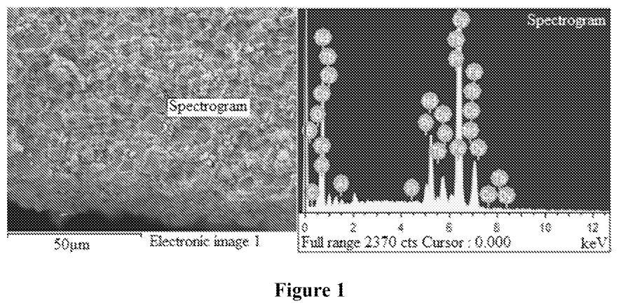

Reference can be made to FIG. 1, which is an EDS spectrogram of a cross section of the magnet sample 3 prepared according to the first embodiment of the present application.

### Second Embodiment

The N56 blanks in the first embodiment were provided. Each of the blanks was cut into square pieces of 40*20*6 (mm), and there are 180 sample pieces in total. The sample pieces were divided into 3 groups with 60 pieces in each group.

The first group was the original sample of the base material with no coating or diffusion treatment, to serve as the comparative sample 1.

The second group: the sample pieces in the second group were coated with the prepared mixture of Tb metal powder and silicone oil evenly on six surfaces by specialized special coating equipment, and the amount of Tb was 0.1% of the sample weight; the 60 coated sample pieces were placed in a vacuum diffusion furnace; first, the temperature was held at 400° C. for 4 hours to dry the silicone oil, and the silicone oil was discharged into the diffusion furnace through the vacuum system of the vacuum furnace; then the temperature was raised to 700˜1000° C. for grain boundary diffusion treatment with a diffusion time of 5 hours; after the diffusion was completed, the temperature was rapidly lowered to below 80° C. and then raised to 500° C. for aging treatment with an aging time of 5 hours; and after the aging treatment was completed, the temperature was rapidly lowered to below 80° C. again for taking the sample pieces out of the furnace, and 60 treated sample pieces were obtained to serve as the comparative sample 2.

The third group: the sample pieces in the third group were coated with the prepared mixture of Tb metal powder and silicone oil evenly on six surfaces by specialized coating equipment, and the amount of Tb was 0.2% of the sample weight; the 60 coated sample pieces were placed in a vacuum diffusion furnace; first, the temperature was held at 400° C. for 4 hours to dry the silicone oil, and the silicone oil was discharged into the diffusion furnace through the vacuum system of the vacuum furnace; then the temperature was raised to 700˜1000° C. for grain boundary diffusion treatment with a diffusion time of 5 hours; after the diffusion was completed, the temperature was rapidly lowered to below 80° C. and then raised to 500° C. for aging treatment with an aging time of 5 hours; and after the aging treatment was completed, the temperature was rapidly lowered to below 80° C. again for taking the sample pieces out of the furnace, and 60 treated sample pieces were obtained to serve as the comparative sample 3.

A magnetic performance comparison test was performed on the three groups of samples, and the results are shown in Table 3:

TABLE 3
Magnetic performance data of the three groups of samples

| Sample | Tb | Br | HCb | HCJ | Hk/ | BH(MAX) |
|---|---|---|---|---|---|---|
| type | amount | (kGs) | (KOe) | (KOe) | HCj | (MGsOe) |
| Comparative | 0% | 14.99 | 12.95 | 13.07 | 0.98 | 54.21 |
| sample 1 | | | | | | |
| Comparative | 0.10% | 14.95 | 14.22 | 18.25 | 0.98 | 53.94 |
| sample 2 | | | | | | |
| Comparative | 0.20% | 14.91 | 14.49 | 21.47 | 0.98 | 53.75 |
| sample 3 | | | | | | |

It can be seen from Table 3 that by performing the three-dimensional grain boundary diffusion process with minute amount of diffusion of 0.10% Tb or 0.20% Tb, a magnetic hardened layer was formed on the surface of the magnet, and a 56SH grade magnet with ultra-high performance of Br: 14.91 kGs and Hcj: 21.47 kOe is obtained, and such performance cannot be achieved by traditional non-diffusion process.

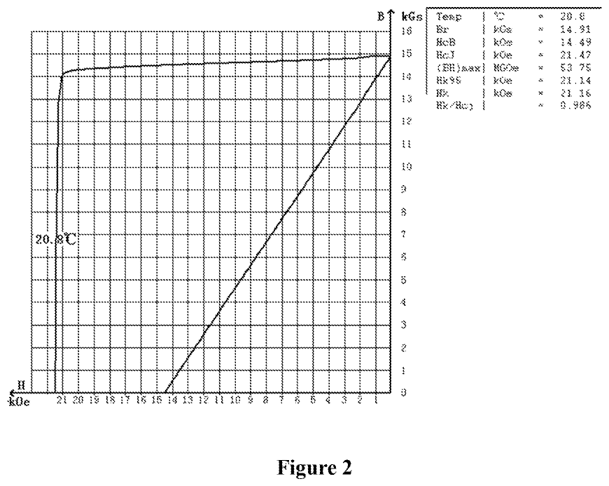

Reference can be made to FIG. 2, which is a graph showing the performance data of the comparative magnet sample 3 prepared in the second embodiment of the present application.

The neodymium-iron-boron magnet and the method for producing the neodymium-iron-boron magnet by three-dimensional grain boundary diffusion provided in the present application have been described in detail above, and the principle and implementation of the present application have been illustrated by using specific embodiments herein. The description of the above embodiments is only used to help understand the method of the present application and its core idea, including the preferred solutions, which also enables those skilled in the art to implement the present application, including manufacturing and use of any equipment or system, and to implement any combined method. It should be noted that for those of ordinary skill in the art, several improvements and modifications can be made to the present application without departing from the principle of the present application, and these improvements and modifications also fall within the protection scope of the claims of the present application. The scope of protection of the present application is defined by the claims, and includes other embodiments conceivable for those skilled in the art. If these other embodiments have structural elements that are not different from what is expressed by the words in the claims, or if they include equivalent structural elements that are not substantially different from what is expressed by the words in the claims, these other embodiments should also be included in the scope of the claims.

1. A neodymium-iron-boron magnet, wherein
the neodymium-iron-boron magnet is subject to diffusion and permeation of a heavy rare earth element;
the neodymium-iron-boron magnet comprises: a heavy-rare-earth grain-boundary diffusion region at a surface layer, and a core non-diffusion region;
the neodymium-iron-boron magnet has the heavy-rare-earth grain-boundary diffusion region at regions, which have normal directions consistent with three axes of a three-dimensional Cartesian coordinate system, of the surface layer; and
wherein the heavy-rare-earth grain-boundary diffusion region is located at each surface of the neodymium-iron-boron magnet.

2. The neodymium-iron-boron magnet according to claim 1, wherein
the heavy rare earth element comprises Dy and/or Tb; and
a volume fraction of the core non-diffusion region in the neodymium-iron-boron magnet is greater than or equal to 20%.

3. The neodymium-iron-boron magnet according to claim 1, wherein
the diffusion and permeation is three-dimensional grain boundary diffusion;
and
an amount of the heavy rare earth element after the diffusion and permeation accounts for 0.1 wt % to 1.0 wt % of a mass of the neodymium-iron-boron magnet.

4. The neodymium-iron-boron magnet according to claim 1, wherein
a content of the heavy rare earth in the core non-diffusion region does not increase before and after the diffusion and permeation;
a depth of the heavy-rare-earth grain-boundary diffusion region with respect to an outer surface of the corresponding surface layer of the neodymium-iron-boron magnet is within 80% of a distance from the outer surface to a center of the neodymium-iron-boron magnet; and
an Hcj of the neodymium-iron-boron magnet is increased by 2 kOe to 15 kOe by the diffusion and permeation.

5. The neodymium-iron-boron magnet according to claim 1, wherein
in the heavy-rare-earth grain-boundary diffusion region and along an extending direction of the surface layer, a concentration of the heavy rare earth element at an edge is greater than a concentration of the heavy rare earth element in a central portion;
in the heavy-rare-earth grain-boundary diffusion region and along an extending direction of the surface layer, the concentration of the heavy rare earth element first gradually decreases and then remains constant from the edge to the central portion; and
in a depth direction of the heavy-rare-earth grain-boundary diffusion region toward a center of the neodymium-iron-boron magnet, the concentration of the heavy rare earth element gradually decreases.

6. A method for producing a neodymium-iron-boron magnet, comprising following steps:
mixing a heavy rare earth with an organic solvent to obtain a mixed solution;
coating the obtained mixed solution on each surface of a raw neodymium iron boron to obtain a semi-finished product; and
performing grain boundary diffusion and aging treatment to the semi-finished product obtained to obtain the neodymium-iron-boron magnet.

7. The method according to claim 6, wherein
the organic solvent comprises silicone oil;
an average particle size of the heavy rare earth ranges from 1 μm to 100 μm; and
a mass ratio of the heavy rare earth to the organic solvent is a ratio of a number ranging from 90 to 98 to a number ranging from 2 to 10.

8. The method according to claim 6, wherein
the raw neodymium iron boron comprises a raw neodymium iron boron after surface polishing treatment;
the grain boundary diffusion is specifically carried out under vacuum conditions;
an absolute pressure of a vacuum is less than or equal to 10 Pa; and
the grain boundary diffusion comprises a step of low-temperature volatilization and a step of high-temperature diffusion.

9. The method according to claim 8, wherein
a temperature of the low-temperature volatilization ranges from 300° C. to 500° C.;
a time of the low-temperature volatilization ranges from 3 h to 5 h;
a temperature of the high-temperature diffusion rages from 700° C. to 1000° C.; and
a time of the high-temperature diffusion ranges from 1 h to 100 h.

10. The method according to claim 9, wherein
the aging treatment is specifically performed after cooling after the high-temperature diffusion;
a temperature of the aging treatment ranges from 400° C. to 600° C.; and a time of the aging treatment ranges from 1 h to 15 h.
